(19) United States
(12) Patent Application Publication
(10) Pub. No.: US 2006/0243830 A1
(43) Pub. Date: Nov. 2, 2006

(54) Auto shredder air scrubber

(76) Inventor: Leroy R. Josephs, North Royalton, OH (US)

Correspondence Address: PEARNE & GORDON LLP, 1801 EAST 9TH STREET, SUITE 1200, CLEVELAND, OH, 44114-3108, US

(21) Appl. No.: 11/115,627

(22) Filed: Apr. 27, 2005

(51) Int. Cl. B02C 23/00

(52) U.S. Cl. 241/19; 241/189.1

(57) ABSTRACT

A system for shredding scrap autos and the like comprising a shredder having a rotary hammer, a closed circuit air flow path, a fan for maintaining an airflow through the path, the airflow path having a section that enters and exits the shredder and is capable of entraining substantially all of the smoke and fines produced or released in the shredder, and an air cleaning section for removing the fugitive dust, smoke, and fines from the air circulating in the path.

### BACKGROUND OF THE INVENTION

The invention relates to improvements in shredding apparatus and, in particular, apparatus for recycling shredded material such as scrapped automobiles and like material.

### PRIOR ART

Millions of automobiles are scrapped each year in the United States. A common method of disposing of these automobiles (hereinafter “cars”) involves a shredding operation in which, for the most part, a whole car is fed into the device. The shredding device is essentially a hammermill which tears apart the scrapped car and reduces it to relatively small fragments. Present day shredding machines can shred in excess of 250 to 300 cars per hour. The shredding process, in addition to producing fragments from the various components of a car produces smoke (sub-micron particles) due to the heat mechanically generated in the process and very small particles or fines which become airborne and are prone to escape the confines of the shredder housing and area to which it discharges. Prior arrangements supplied a substantial vacuum, measured for example in inches of water, to the conveyor conducting the discharge from a shredder that was intended to pick-up large quantities of lightweight fragments often referred to in the industry as “fluff”. At the same time, the vacuum-induced airflow carried off some of the smoke and fines produced within the shredder. However, the airflow circuit typically found in conventional prior art shredding systems is “open” such that after being filtered and/or centrifugally separated, air was exhausted directly and wholly to the atmosphere. The horsepower expended in separation of large quantities of fluff from the heavier materials with air at this location in the system is considerable and represents a significant cost in the operation of a system. In summary, prior art shredders typically fail to capture essentially all of the smoke and airborne fine (sub-micron) particles, as are generated and the associated forced air separation system was expensive to operate.

### SUMMARY OF THE INVENTION

The invention provides an improved shredder and material separation system for recycled materials and shredding scrapped automobiles and the like which essentially eliminates escape of steam, smoke, and airborne fines to the atmosphere and which operates with an air circulation circuit that requires considerably less energy input than prior art systems. The shredder is swept or otherwise influenced by an essentially “closed” airflow circuit that introduces filtered and/or centrifugally separated air at the lower side of the shredder housing and extracts the air carrying the smoke and fines produced or otherwise released during the shredding operation in one embodiment from the upper side of the housing. The air flow adjacent the opening through which cars are fed into the shredder housing is essentially at atmospheric pressure so that no significant volume of air passes out of the shredder housing opening and all the while any smoke or fines near this opening are swept into an air cleaning and/or separation circuit. The entrance for the scrapped cars or other material can, as disclosed, be sealed with a supplemental air curtain circuit.

The shredder deposits fragmented material onto an underlying conveyor which carries such shredded material to a belt conveyor. The belt conveyor brings the shredded material to two serially arranged magnetic roll separators. Non-ferrous materials (both metals and non-metals) drop onto an underlying conveyor that takes them to an eddy current separator trommel or screening separation system (process) that removes non-ferrous metals from the remaining non-metallic materials such as plastics and rubber, and including large portions of resultant fluff. The ferrous materials are diverted and transferred by conveyor to a material separation system such as a cascade box and a cyclone separator “closed” system where relatively light generally non-metallic materials that may have been entangled or intertwined with the ferrous materials are air-separated from the ferrous materials.

By producing a “closed” flow draft through and along the shredder, smoke and fines are effectively captured with significantly reduced power consumption. Light materials, largely fluff, are allowed to pass out of the shredder along with other heavier materials in the material flow path of the system where, to a large extent, they can be advantageously separated by drum magnets and further by electromechanical forces at an eddy current separator.

### BRIEF DESCRIPTION OF THE DRAWINGS

FIGS. 1A and 1B are left and right parts of an elevational view of a material recycling system employing the invention;

FIGS. 2A and 2B are left and rights parts of a plan view of the system of FIGS. 1A and 1B, respectively;

FIG. 3 is an enlarged view of the shredder portion of the system;

FIG. 4 is a view similar to FIG. 3 with a modification of the air duct system;

FIG. 5 is an enlarged somewhat schematic view of a magnetic drum separation area of the system illustrating a modified form of material separation;

FIG. 6 is a schematic view of an air knife used to separate material of different density;

FIG. 7 is a view similar to FIG. 5 with an additional modified form of material separation; and

FIG. 8 is a view of an air knife used in the modification of FIG. 7.

### DESCRIPTION OF THE PREFERRED EMBODIMENT

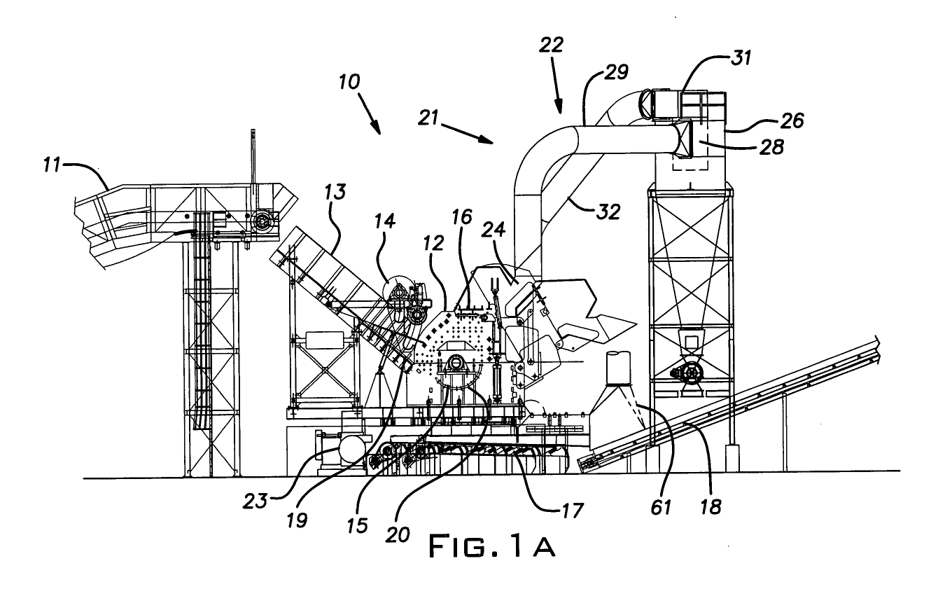

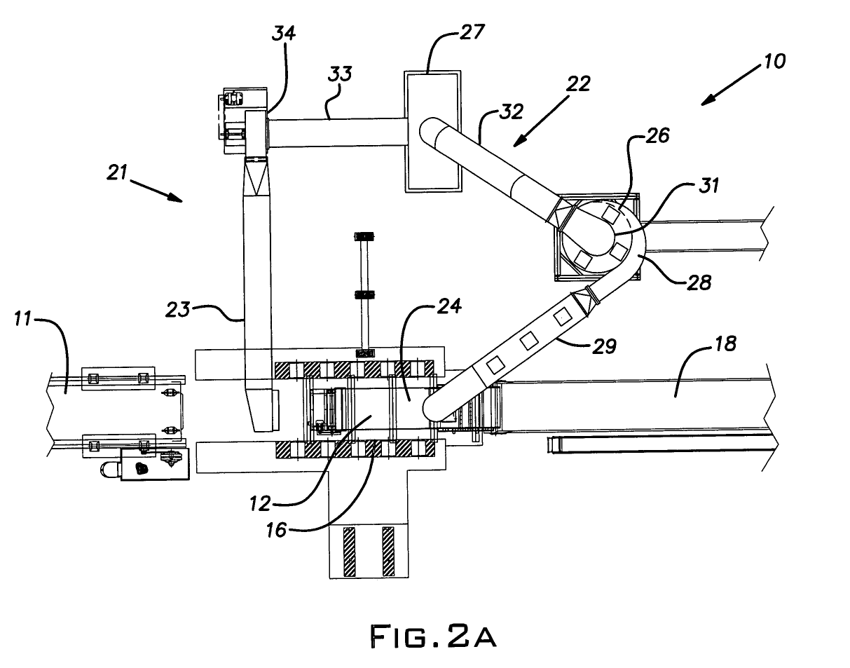

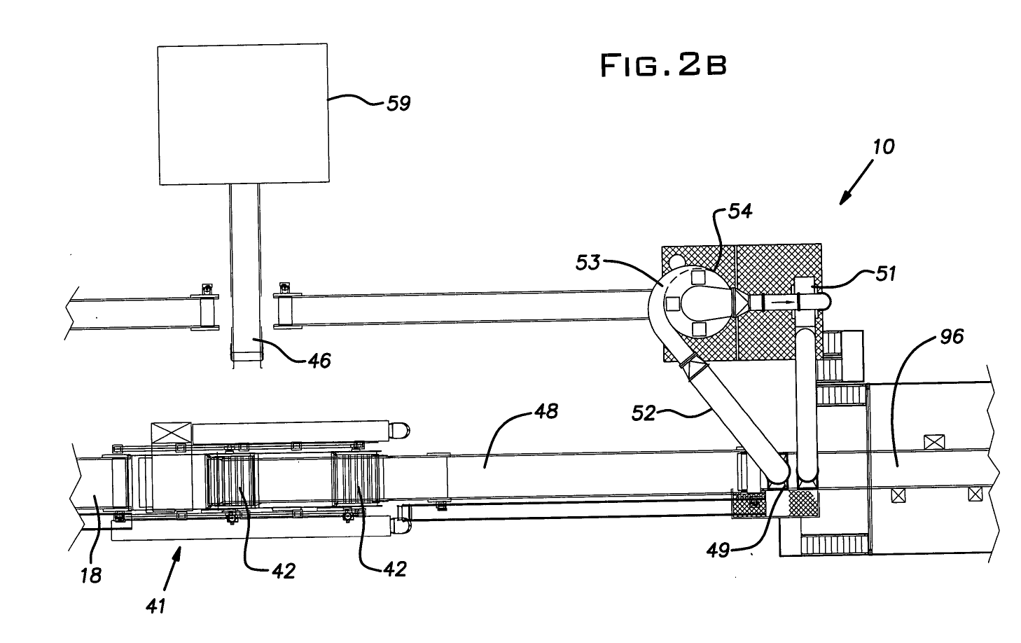

There is shown in the figures, a system for recycling the material content of various recycled material and scrapped road vehicles, mostly autos, which term will be understood to include automobiles, vans, SUVs, light trucks, and the like, and parts thereof. In the operation of systems like that illustrated, the goal is to obtain high purity ferrous and non-ferrous metal products with low energy expenditure. As explained in more detail below, scrapped cars are supplied at the left by a conveyor 11 in FIGS. 1, 2 and 3, and are fed towards the right to a shredder 12, and the shredded auto material is directed, more or less, to the right in the figures, to various material separation stations. The auto supply in-feed conveyor 11 carries largely whole autos to a downwardly inclined chute 13 that guides successive autos into the entrance to the shredder 12. At a lower end of the chute 13 a metering/compression roll 14 meters the rate at which a car or auto is fed into the shredder 12. The powered metering roll 14 compresses scrap descending on the gravity chute 13 to a degree that enables the metering roll to feed the scrap at a moderate efficiently controlled rate to the shredder. An air seal system such as a conventional air curtain with a supply 19a (FIGS. 3, 4), known in the art, is disposed into the lower end of the gravity chute 13 and the entrance to the shredder housing 16 to prevent escape of airborne particles from within the shredder 12 to the environment. The air curtain, in a conventional manner, has an associated fan or blower that maintains a constant flow of ambient air in a plane across or transverse to the direction of travel of the autos into the shredder housing 16. A first variant of this air curtain arrangement with suitable directing can employ the positive pressure side of a system fan 34 discussed below. A second variant of the air curtain arrangement with appropriate directing can employ the suction side of the system fan 34.

The shredder 12 is of a generally conventional construction having a box-like housing in which a rotary hammer assembly 15 rotates about a horizontal axis perpendicular to the line of movement of scrap through the chute 13 and metering/compression roll 14. The rotary hammer assembly of the shredder, driven, for example, by a large electric motor, shreds an auto into fragments small enough to pass through a grid or grate 20 with, for example, six inch openings conventionally arranged in the shredder housing 16 surrounding a lower portion of the rotary hammer assembly 15. The shredded elements or fragments of an auto that pass through the grid openings, fall through the openings of the grate 20 to the bottom of the housing 16 onto a conveyor 17 of a vibratory or oscillating type. The conveyor 17 sends fragmented material to an elevating transfer conveyor 18. The space above the conveyor 17 is closed by a housing 17a and sealed by a rotary flap seal 25 (FIG. 3) or a stationary hanging flap seal. The rotary seal 25 rotates at a tip speed matched to the conveying speed of the conveyor 17.

The shredder 12, which can be capable of shredding in excess of 250 to 300 autos per hour consumes considerable power and develops heat which, in turn, produces steam from any moisture and water existing in the autos as well as from the water injection system. Additionally, the shredder 12 produces and/or releases dust particles sometimes referred to as “fluff/fines”. In general, submicron particles, once airborne, will persist in this condition for some time, if not indefinitely, where air is circulating at even moderate velocities. It is important that these airborne particles, particularly the heavy metals and the smoke being produced in the shredder 12 not be released to the atmosphere.

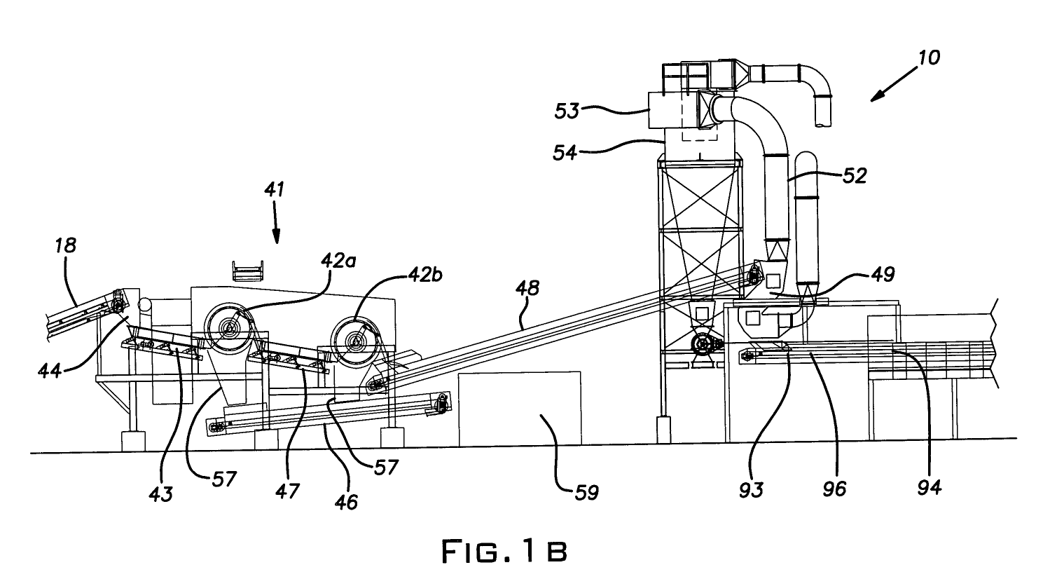

A “closed” loop airflow path or circuit 21, including an air cleaning and/or separation section 22, is arranged to capture the airborne fines and smoke being generated and/or released in the shredder 12. The air circuit 21 includes a return duct 23 that admits separated or cleaned air to the underside of the grid/grate at the bottom of the shredder housing 16 and/or hood 24 that draws air laden with fines and smoke out of the top of the shredder. The air cleaning section 22 of the closed loop circuit 21, in the illustrated arrangement at FIG. 2a, includes a cyclone separator 26 and a secondary air cleaning device 27. The cyclone separator 26 is a high efficiency unit of generally conventional in construction, having a tangential inlet 28 connected by a duct 29 to the hood 24 overlying the shredder housing 16 and/or top suction of shredder housing 24. A central outlet 31 of the cyclone separator 26 is connected to the secondary air cleaning device 27 through a duct 32. The air cleaning device 27, depending on the circumstances and/or application, can be any one of a number of known air cleaning systems including a dry fabric mesh filter that is renewed as needed by advancing a used portion onto a take-up drum and a fresh portion from a supply roll or, a wet scrubber such as the type using water flooded chamber with polyethylene balls. A duct 33 permits air to be drawn through the cleaning or separation device 27 by the fan 34, typically in the form of a centrifugal blower. The fan 34 returns the cleaned or separated air to the underside of shredder 12 through the duct 23 at the underside of the grid area at the bottom of the shredder 12.

The result of drawing air off the top of the shredder 12 at the hood 24 and return-recycled air at the bottom of the shredder 12, is a continuous draft or flow of air through the shredder bottom that entrains airborne fines and smoke being produced and/or released in the shredding process. The disclosed “closed” path air circuit besides advantageously eliminating dust and smoke emissions to the atmosphere enables the circuit to operate at relatively low pressure and resulting in less horsepower consumption. The recycled air closed loop system operates at a relatively low pressure at the supply side, e.g. at the duct 23, delivering cleaned or separated air to the bottom of the shredder and operating at 16 to 25 inches of water above atmospheric pressure. This low pressure operation reduces initial system cost by reducing the size of the related components and significantly reduces operating costs, i.e. less horsepower.

Airflow at the shredder that captures smoke and airborne particles or fines may be modified from that disclosed hereinabove in connection with FIGS. 1A and 3. For example, as shown in FIG. 4 where identical or similar parts are identified with the same numerals, the air flow can enter the area of the shredder at the upstream end of the oscillator/vibratory conveyor 17 through the return duct 23, sweep into the bottom of the shredder housing 16 below the grate or grid 20 and exit the bottom of the shredder at the downstream end of the conveyor 17. This modification involves rearranging the duct 29′ to the cyclone separator 26 so that it draws air from the underside of the shredder through a hood 61 rather than from the upper side of the shredder as is shown in FIGS. 1A and 3 at 24. In cases where air is drawn out of the top of the shredder through the hood 24, drawn out of the bottom of the shredder through the hood 61 or both hoods, an air flow of sufficient volume and rate is established to entrain substantially all of the fines and smoke produced and/or released in the shredder.

The elevating transfer conveyor 18 carries shredded product or fragments to a station 41 having a serially arranged set of magnetic separator drums 42a and 42b. A first vibratory conveyor 43 carries shredded fragments from a chute 44 at the end of the elevating transfer conveyor 18 to a first one of the magnetic separator rolls 42a. The magnetic separator rolls 42a, 42b separate the ferrous material from the fragments produced at the shredder 12 and allows the non-magnetic residual to fall through the chutes 57 to a conveyor 46 under the magnetic rolls 42a and 42b. Ferrous material attracted by the first magnetic roll 42a is stripped or released from it and deposited on a second vibratory conveyor 47. This second vibratory conveyor 47 transfers material from the first roll 42a to the second magnetic roll 42b to refine the material separation such that non-magnetic material loosely attached to magnetic material at the first roll 42a is not attracted to the second roll 42b and eventually drops to the lower conveyor 46. Magnetic material is stripped or released from the second magnetic roll 42b and deposits on an elevating transfer conveyor 48 (FIGS. 1B and 2B).

The elevating transfer conveyor 48 carries the magnetic or ferrous material fragments to a Z-box or cascade separator 49. At the cascade or Z-box separator 49, as generally known in the art, a tumbling action of the primarily ferrous material dislodges intertwined or otherwise entangled non-ferrous material, which is largely fluff/fines and non-ferrous particles from the ferrous material. The dislodged non-ferrous material, etc. is separated from the ferrous material by an airstream recycled/returned and forced into the bottom of the Z-box 49 and exhausted out the top of the Z-box. This airstream or airflow is developed by a fan 51 in the form of a centrifugal blower. The air out of the Z-box is directed through a duct 52 to the inlet 53 of a cyclone separator 54. Non-ferrous, relatively light solid particles or fragments separated from the ferrous materials in the cascade box 49 are separated from the air in the cyclone separator 54 in a generally known manner. Ferrous material exits the bottom of the Z-box 49 by gravity onto a conveyor 96. The space adjacent the bottom of the Z-box over the conveyor 96 is sealed upstream by a hanging fixed seal or a rotary seal at 93 and downstream by a hanging fixed seal or rotary seal at 94. Resultant ferrous material exits to storage and/or shipping.

Non-magnetic (non-ferrous) fragmentary material, i.e. material not attracted to the magnetic rolls 42a and 42b drops down through the chutes 57 to the conveyor 46 that transports it to a separation station 59 in the form of a trommel or an eddy current separator system 59. The eddy current separator system 59, generally known in the art, is very efficient in electro-mechanically separating non-ferrous metals from the remaining fragmented material, which is largely composed of non-metallic fluff.

It has been discovered that overall operating efficiency can be increased by separating fluff from metal content of the shredded cars by more cost effective techniques other than direct air separation. This is accomplished as disclosed by separating ferrous metals from the shredded product with a magnetic separator and separating the non-ferrous metals from the shredded product with an eddy current separator system. That is to say, a majority of the fluff is simply conveyed from station-to-station to separate ferrous and non-ferrous metals without mass air separation of fluff from heavier metal fragments.

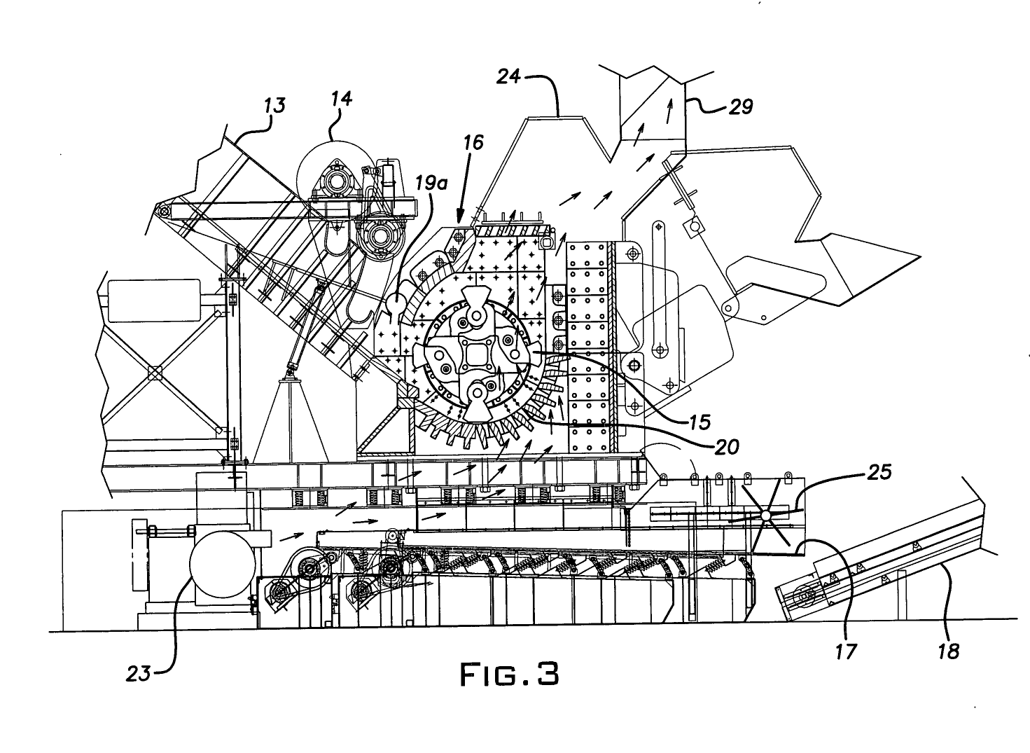

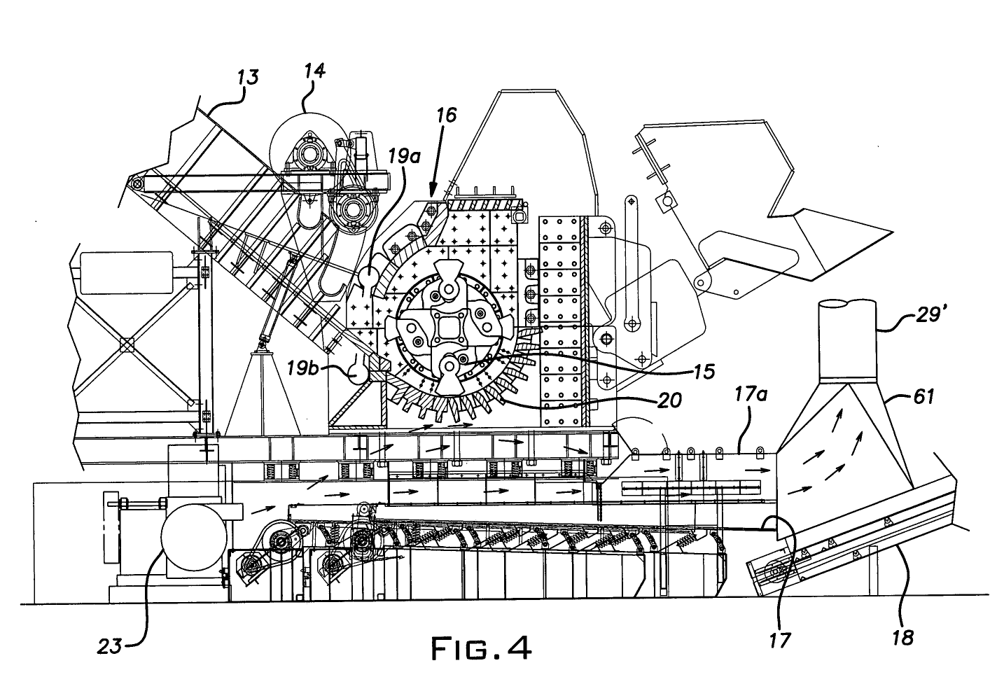

In systems that operate at relatively low tonnage capacity, for example of about in the range of 30 tons per hour, the cyclone separator 26 can be eliminated on a cost/benefit basis. FIG. 5 illustrates such a system 70; the same numerals are used to identify the same or like parts as disclosed hereinabove. In the system 70, a fan 71 blows/returns air through a nozzle 72 (FIG. 6) to develop an air knife or high velocity air jet 73 fully across the free fall path of the material coming off the magnetic drum 42. This system can also be utilized with an individually powered air knife. The air knife or jet 73 is oriented generally transverse to the material free fall path 75. The jet 73, while relatively narrow in the direction of material flow, extends across the full width of the path corresponding to the width of the drum 42b.

The air knife jet with a velocity as high as about 12,000-14,000 feet per minute impinges on material coming from the magnetic drum 42b, loosens the lightweight material from the heavy ferrous materials, and deflects the lighter density materials (e.g. fluff) out of the free fall path of material in the direction of the air jet. This deflection enables the materials of different density to be separated, with the light density material such as fluff/fines being collected in a hopper 76, for example, and the heavier mostly ferrous materials being received in a transfer chute 77 and then to a stacking conveyor 78.

The hopper 76 can be covered with air permeable fabric to permit it to work as a filter and thereby enable the air in the hopper to remain at atmospheric pressure.

The fan 71 is connected to the air knife push/return nozzle 72 by a duct 79. A duct 81 connects the inlet of the blower of fan 71 to a pull knife or suction nozzle 82 in the hopper 76. The pull air knife nozzle 82 is situated on the opposite side of the free fall path of material from the push air knife nozzle 72. The pull knife nozzle 82 can be configured or oriented so that light density material is separated from the air stream by the inertia of this material and the effect of gravity so that it falls towards the bottom of the hopper 76. Material in the hopper 76 can be conveyed to the eddy current separator 59 for further separation of material.

An air knife, such as the unit employing the push nozzle 72 and pull nozzle 82 at the transfer chute serving the magnetic rolls 42, can be used at any other transfer point or chute arrangement where material is in a free fall condition to separate light density materials from heavier density materials. For example, an air knife can be used, if desired, at the transfer area between the shredder conveyor 17 and the transfer conveyor 18, at the transfer chute 44 leading to the magnetic separator rolls 42, and at a transfer chute to the eddy current separator at the station 59.

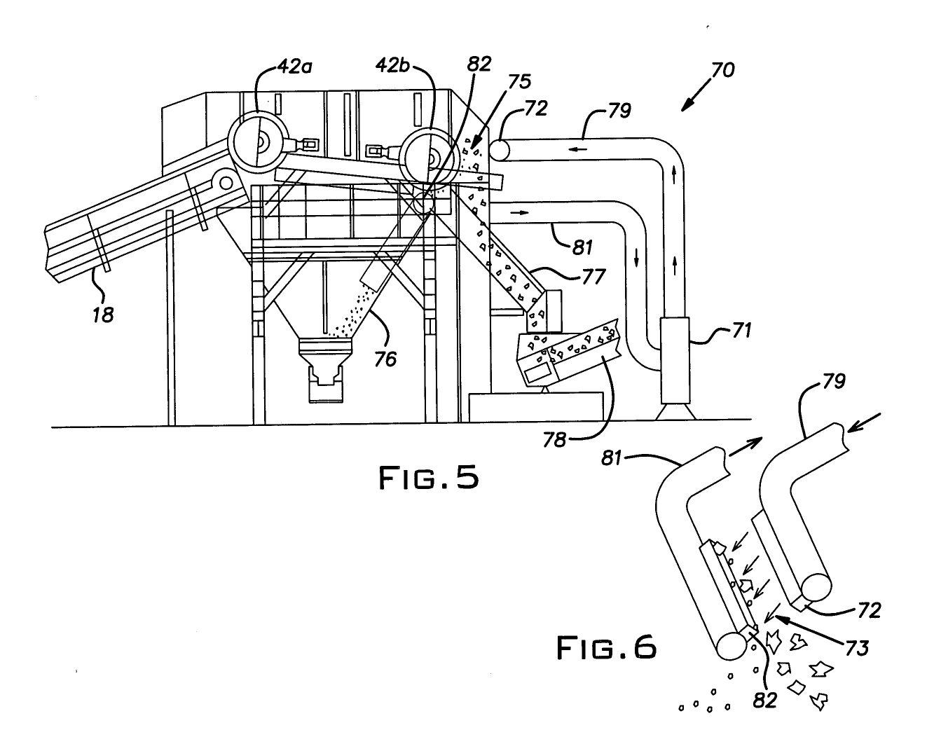

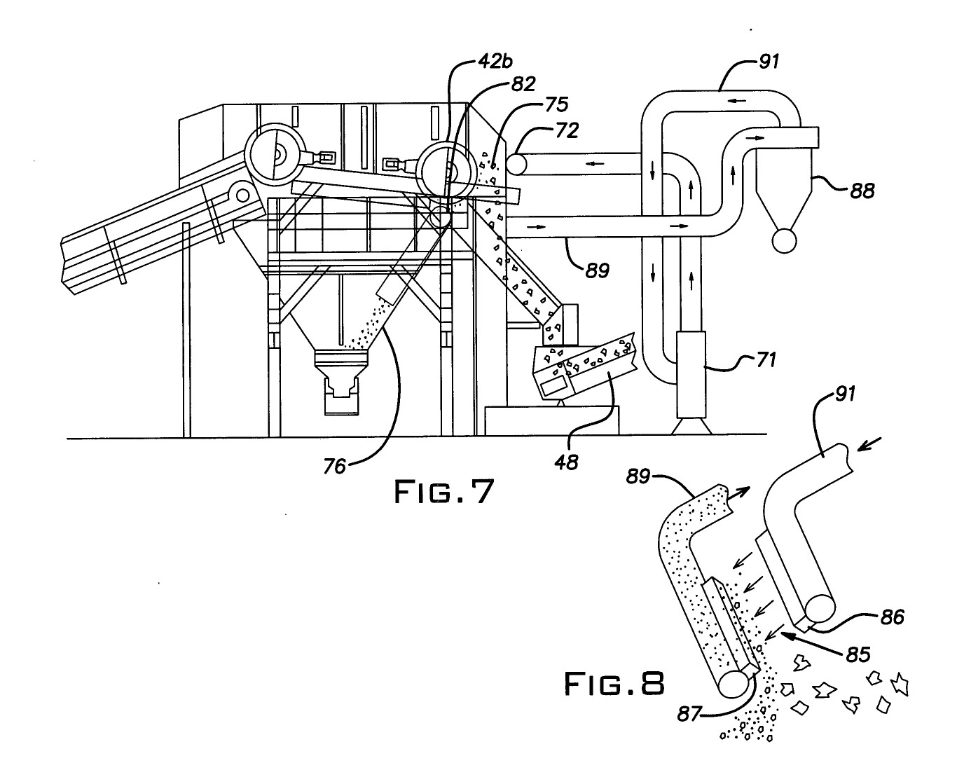

In moderate capacity installations, in the range of about 60 tons per hour, for example, it can be desirable to increase the efficiency of separation of light density material from the air stream created between a push and pull air knife arrangement. Referring to FIGS. 7 and 8, where the same or similar parts are identified with the same numerals previously used, an air knife 85 comprises a push nozzle 86 and a pull nozzle 87. The nozzles are constructed so that they extend across the full width of the material free fall path and are arranged to produce an air jet that is generally transverse to the path of material in its free fall.

A cyclone separator 88 is connected in series by ducts 89, 91 with the suction side of the fan 71. Relatively light density material entrained by the air of the air knife, designated 85, is carried through the pull nozzle 87 and duct 89 into the cyclone separator 88 where it drops out of the air stream. Moderate density material is deflected from the free fall path off the magnetic drum 42b and caused to fall into the hopper 76 while denser material is directed to the conveyor 48.

The embodiments of FIGS. 5, 6 and FIGS. 7, 8 are capable of efficiently operating with smaller fans or blowers than employed in the system of FIGS. 1-4 and, therefore, reduce the initial cost and the operating cost of these respective installations.

A rotary seal, like the seal 25 at the discharge of the shredder conveyor 17 (FIG. 3), can be used in locations in the disclosed systems where the difficulty in containing dust is severe. Such additional locations, as mentioned, may include the upstream and downstream ends 93, 94 of the conveyor 96 (FIG. 1B) carrying material discharged from the bottom of the Z-box 49. The rotary seal includes a plurality of resilient flaps fixed to a rotating shaft. The shaft is preferably power driven in rotation with any associated conveyor so that the tip speed of the flaps is synchronized with the transport speed of the conveyor. The tips of the flaps are arranged to reach and seal against the surface of the associated conveyor or material lying on the conveyor. The system 10 as disclosed or with suitable modification within the skill of those working in the art can be used to shred other waste materials besides cars, such as municipal waste.

While the invention has been shown and described with respect to particular embodiments thereof, this is for the purpose of illustration rather than limitation, and other variations and modifications of the specific embodiments herein shown and described will be apparent to those skilled in the art all within the intended spirit and scope of the invention. Accordingly, the patent is not to be limited in scope and effect to the specific embodiments herein shown and described nor in any other way that is inconsistent with the extent to which the progress in the art has been advanced by the invention.

What is claimed is:

1. A system for shredding recycled materials and scrap autos and the like comprising a shredder having a rotary hammer assembly, a closed circuit air flow path, a fan for maintaining an airflow through the path, the airflow path having a section that enters and exits the shredder and is capable of entraining substantially all fugitive dust, smoke, and fines produced or released in the shredder, and an air cleaning section for removing the smoke and fines from the air circulating in the path.

2. An system as set forth in claim 1, wherein the movement of air in the path through the shredder is in counterflow to movement of the auto material to the shredder.

3. A system as set forth in claim 1, wherein the air cleaning section includes a cyclone separator.

4. A system as set forth in claim 3, wherein said air cleaning section includes an air cleaning device in the closed air path downstream from said cyclone separator.

5. The system as set forth in claim 4, wherein said air cleaning device is a dry filter.

6. A cleaning device as set forth in claim 4, wherein said air cleaning device is a wet scrubber.

7. A system as set forth in claim 1, wherein said fan is arranged to draw off smoke and fines from said shredder while leaving substantially all of the fluff created in the shredder for gravity flow out of the bottom of the shredder.

8. A system as set forth in claim 7, including a fragmented material flow path for receiving material fragmented in the shredder, the material flow path including a magnetic separating station for separating ferrous material from other materials shredded in the shredder.

9. A system as set forth in claim 8, wherein the material flow path includes an eddy current separator for separating non-ferrous metal from other material shredded in the shredder.

10. A system as set forth in claim 9, wherein the eddy current separator is downstream of said magnetic separator, the shredder, air cleaning section and magnetic separator being arranged to direct the bulk of fluff produced in the shredder to the eddy current separator.

11. A method of operating a shredder for scrap autos and the like, the shredder being arranged with an entrance for receiving autos, establishing a forced air draft to remove fugitive dust, smoke, and fines released in the shredding operation, continuously recycling the air in the forced draft in a closed loop that includes an air cleaning section, the static pressure of the air draft at the entrance being balanced with ambient atmospheric pressure whereby there is essentially no loss or gain of air into or out of the forced draft through the entrance.

12. A method of separating materials of different density from a mix of such materials comprising directing the mix into a free fall path, exposing the mix in the path to a high velocity air jet stream that is flowing in a direction that is generally transverse to the path such that the air stream influences the relatively lighter density material to a larger extent than the relatively heavier density material to deviate from the free fall path, collecting relatively heavy density material in a first location, and relatively light density material in a second location.

13. A method as set forth in claim 12, wherein the second location is displaced relative to the first location in a direction aligned with said air stream flowing direction.

14. A method as set forth in claim 12, wherein the air jet stream is propelled at a speed of about 12,000-14,000 feet per minute.
